(19) United States
(12) Patent Application Publication
(10) Pub. No.: US 2026/0059061 A1
(43) Pub. Date: Feb. 26, 2026

(54) INFORMATION PROCESSING APPARATUS FOR ENABLING APPROPRIATE SHUTDOWN OF AN IMAGE FORMING APPARATUS, CONTROL METHOD THEREFOR, AND COMPUTER PROGRAM PRODUCT

(71) Applicant: CANON KABUSHIKI KAISHA, Tokyo (JP)

(72) Inventor: TAKUMI URYU, Chiba (JP)

(21) Appl. No.: 19/291,889

(22) Filed: Aug. 6, 2025

(30) Foreign Application Priority Data
Aug. 26, 2024 (JP) 2024-144218

(51) Int. Cl. H04N 1/00

(52) U.S. Cl. CPC H04N 1/00891; H04N 1/00925

(57) ABSTRACT

An information processing apparatus is configured to be communicatively connected to an image forming apparatus and shut down the image forming apparatus appropriately. The information processing apparatus includes a controller configured to perform shutdown control to cause the image forming apparatus to execute a shutdown. Upon performing the shutdown control, the controller controls whether to display an operation screen that allows an operation to instruct execution of the shutdown without performing a protective process for protecting components of the image forming apparatus, depending on a logged-in user who has logged in using a maintenance mode that enables maintenance inspection of the image forming apparatus.

### BACKGROUND

### Field of the Technology

The present disclosure relates to an information processing apparatus, a control method for the information processing apparatus, and a computer program product.

### Description of the Related Art

In the field of commercial printing, a printing company continues to use an image forming apparatus, such as a printing device or printer, over a long period of time (e.g., several years or more than a decade). During this time, maintenance inspections are performed on the image forming apparatus, for example, to stabilize quality, replace components, or address malfunctions. There are two types of maintenance inspections for image forming apparatuses. The first type is an operator maintenance inspection performed by an operator of the printing company. In this maintenance inspection, the operator routinely performs calibrations of the image forming apparatus and calibrations or similar adjustments for each type of paper, thereby adjusting color quality. This maintenance inspection also includes operations that do not require specialized training in advance, for example. The second type is a technician maintenance inspection performed by a maintenance technician from the manufacturer or vendor of the image forming apparatus. Even if such technician maintenance inspections are performed, issues such as image defects may still arise in the image forming apparatus due to aging or deterioration of components over time. In such cases, the printing company requests a maintenance inspection from the manufacturer or vendor of the image forming apparatus. In response to the request, a maintenance technician with specialized knowledge conducts the technician maintenance inspection. Since the maintenance technician is dispatched for the technician maintenance inspection, expenses such as labor costs are incurred. These expenses are billed to the printing company, resulting in an impact on its profitability. Accordingly, there is generally a need to improve the efficiency of maintenance technicians'work.

In addition, the technician maintenance inspection may require a shutdown operation to turn off the power of the image forming apparatus. Such a shutdown may affect the progress of printing operations. Consequently, a known technology exists for determining whether to permit the shutdown operation (see, for example, Japanese Patent Application Laid-Open No. 2005-295384). In this conventional technology, an image processing system switches the display of a shutdown button and a logoff button on the operation interface of the image forming apparatus according to attribute information of a user logging into the system and the number of users who have logged in.

When the power of a printer is turned off, a series of processes is performed to shut down the power in response to either the pressing of the power button of the printer or a shutdown command received by the printer. In some printers, a protective process is executed as a pre-shutdown operation to prevent damage to components that are in operation when the power is turned off. For example, a drum, one of the components of a printer, increases in temperature during operation, and if a cooling process is not performed as a protective process before the power is turned off, the drum may be damaged. The time required for such a protective process can range, for example, from 30 minutes to an hour, depending on the nature of the process. That is, maintenance work after the printer is powered off cannot begin until the protective process, which may take 30 minutes to an hour, has been completed. Additionally, this kind of protective process is often configured to be executed automatically whenever the printer is powered off.

Meanwhile, maintenance technicians dispatched from the manufacturer or vendor of the image forming apparatus have received specialized training related to maintenance inspections. Therefore, depending on the type of maintenance inspection, the maintenance technicians may determine that the printer can be powered off without performing the protective process. However, as described above, the protective process is sometimes automatically executed whenever the printer is powered off. As a result, even in cases where the protective process is not necessarily required, a waiting time for the protective process may still occur, which reduces work efficiency and increases the time required to complete the maintenance work.

To address this, it is conceivable to configure the printer to allow selection between a mode in which the protective process is executed and a mode in which the protective process is not executed. In this case, when an operator who has not received specialized training in maintenance inspections turns off the power of the printer, there is a risk that the operator may mistakenly select the mode in which the protective process is not executed, even though the mode in which the protective process is executed should be selected. If the mode in which the protective process is not executed is mistakenly selected, components that are in operation in the printer may be damaged.

It is also conceivable to configure the printer such that the selection of whether to execute the protective process and the operation of turning off the power of the printer can be performed independently. In this case as well, there is a risk that the operator may mistakenly select the option not to execute the protective process when turning off the power of the printer, even though the option to execute the protective process should be selected. Furthermore, if the printing company is unable to determine whether execution of the protective process is necessary, they may always need to request the dispatch of a maintenance technician. However, such an approach is not practical in view of the associated costs.

### SUMMARY

Embodiments described herein are directed to technology for appropriately shutting down an image forming apparatus.

In one embodiment, an information processing apparatus is configured to be communicatively connected to an image forming apparatus. The information processing apparatus includes one or more processors, and at least one memory coupled to the one or more processors and having stored thereon instructions which, when executed by the one or more processors, cause the one or more processors to perform shutdown control to cause the image forming apparatus to execute a shutdown. Upon performing the shutdown control, the one or more processors are further caused to control whether to display an operation screen that allows an operation to instruct execution of the shutdown without performing a protective process for protecting components of the image forming apparatus, depending on a logged-in user who has logged in using a maintenance mode that enables maintenance inspection of the image forming apparatus.

In another embodiment, the one or more processors may further be caused to perform switching control, upon performing the shutdown control, to control whether to display a first operation screen that allows an operation to instruct execution of the shutdown after completion of a protective process for protecting components of the image forming apparatus, or a second operation screen that allows an operation to instruct execution of the shutdown without performing the protective process.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating the general configuration of an information processing system according to a first embodiment.

FIG. 2 is a block diagram illustrating an example of the hardware configuration of an information processing apparatus.

FIG. 3 is a block diagram illustrating the functions (software configuration) of an image forming apparatus.

FIG. 4 is a block diagram illustrating the functions of a web system and a printing company system.

FIG. 5 is a diagram illustrating an example of a login screen.

FIG. 6 is a perspective view illustrating a hardware key used for login.

FIG. 7A is a diagram illustrating example content of a request for user authentication to a service tool.

FIG. 7B is a diagram illustrating example content of a response from the service tool.

FIGS. 8 to 15 are diagrams each illustrating an operation screen that displays information related to the service tool.

FIG. 16 is a flowchart illustrating a process performed by the information processing apparatus in the printing company system.

FIG. 17 is a flowchart illustrating a process performed by the image forming apparatus.

FIG. 18 is a flowchart illustrating a process performed by a service engineer (maintenance technician) for a maintenance task.

FIG. 19 is a flowchart illustrating a process performed by an information processing apparatus in a printing company system according to a second embodiment.

FIG. 20 is a flowchart illustrating a process performed by the information processing apparatus in the printing company system.

FIG. 21 is a diagram illustrating an operation screen that displays information related to a service tool according to a third embodiment.

FIG. 22 is a diagram illustrating an operation screen that displays information related to a service tool.

FIG. 23 is a flowchart illustrating a process performed by an information processing apparatus in a printing company system.

FIGS. 24 to 27 are diagrams each illustrating an operation screen that displays information related to a service tool according to a fourth embodiment.

### DESCRIPTION OF THE EMBODIMENTS

Exemplary embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding parts, and duplicative descriptions thereof are omitted to avoid redundancy.

### First Embodiment

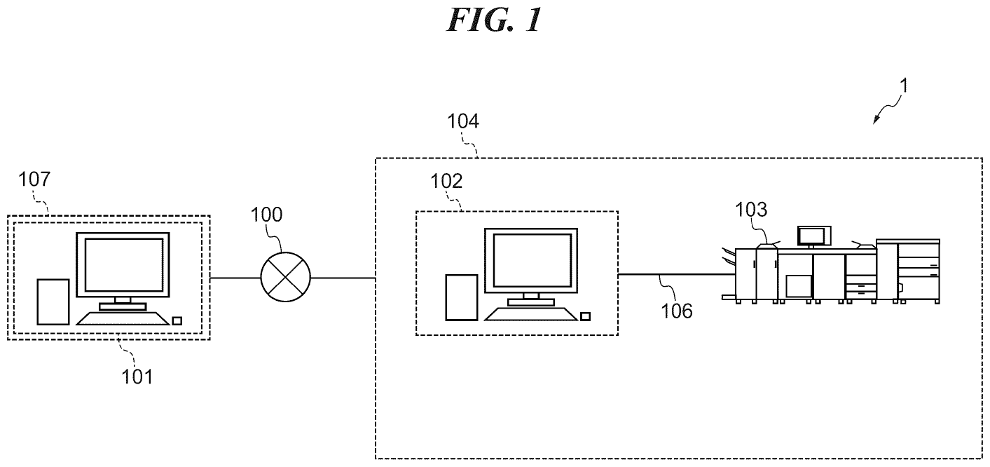

A first embodiment will be described below with reference to FIGS. 1 to 18. FIG. 1 is a schematic diagram illustrating the general configuration of an information processing system according to the first embodiment. As illustrated in FIG. 1, an information processing system (maintenance support system) 1 includes a printing company system 104 and a web system 107, which are communicatively connected with each other via the Internet 100. The printing company system 104 includes an information processing apparatus 102 and an image forming apparatus 103, which are communicatively connected with each other via a network 106. The information processing system 1 is a maintenance support system configured to provide maintenance support for the image forming apparatus 103. The image forming apparatus 103 is controlled by a group of programs running on the information processing apparatus 102. The web system 107 includes an information processing apparatus 101. The image forming apparatus 103 receives print settings, print data, and the like from the information processing apparatus 101. The image forming apparatus 103 can process the print settings, print data, and the like to perform printing. The web system 107 may be implemented as a cloud-based system or a server-based system.

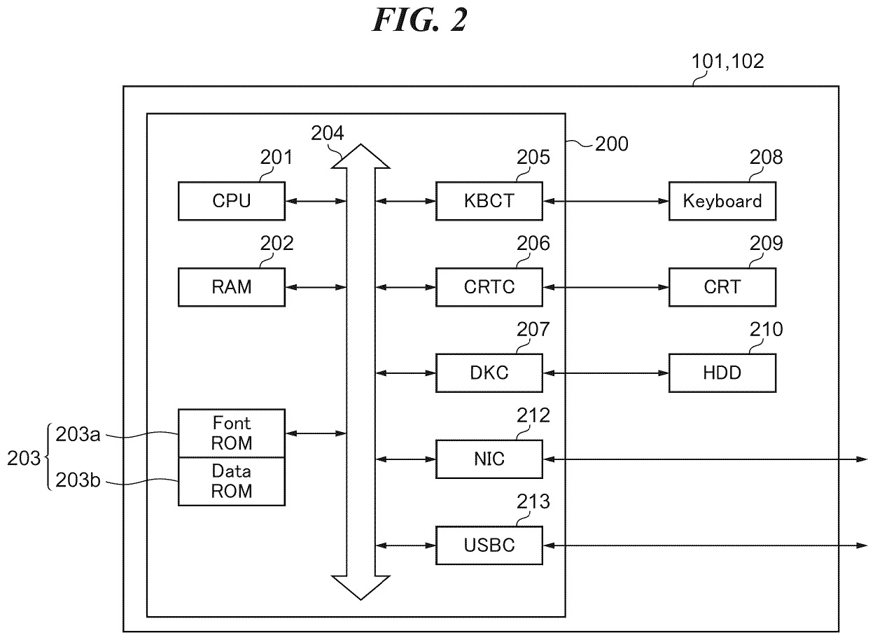

FIG. 2 is a block diagram illustrating an example of the hardware configuration of the information processing apparatus. As illustrated in FIG. 2, the information processing apparatus 101 and the information processing apparatus 102 have the same hardware configuration; therefore, the hardware configuration of the information processing apparatus 102 will be described as a representative example. The information processing apparatus 102 includes a controller 200, a keyboard 208, a display (CRT) 209, and a hard disk drive (HDD) 210, which are capable of communicating with each other. The controller 200 controls the overall operation of the information processing apparatus 102. The controller 200 includes a CPU 201, a RAM 202, a ROM 203, a keyboard controller (KBCT) 205, and a display controller (CRTC) 206. The controller 200 further includes a disk controller (DKC) 207, a network interface controller (NIC) 212, and a USB controller (USBC) 213. These hardware components of the controller 200 are communicatively connected with each other via a bus 204.

The CPU 201 executes programs stored in a program ROM of the ROM 203 or runs an operating system (OS) and various application programs loaded from the HDD 210 into the RAM 202. The programs include, for example, programs for causing a computer to implement various functions and operations of the information processing apparatus 102 (control method for the information processing apparatus). The ROM 203 includes a font ROM 203a and a data ROM 203b. The RAM 202 functions as a main memory for the CPU 201 or as a work area. The keyboard controller 205 controls inputs from the keyboard 208 and a pointing device (not illustrated). The display controller 206 controls display on the display 209. The disk controller 207 controls access to the HDD 210. The HDD 210 stores, for example, a boot program, various application programs, font data, and the like. The network controller 212 controls communication with other devices via a network. The USB controller 213 includes a USB port and controls a USB device connected to the USB port. Examples of the information processing apparatus 102 with such a configuration include, but are not limited to, a desktop or notebook personal computer, a tablet device, and a smartphone. When a smartphone is used as the information processing apparatus 102, the information processing apparatus 102 may include a touch panel controller or the like in place of the keyboard controller 205. The information processing apparatus 102 may include a large-capacity storage device in place of the HDD 210. The information processing apparatus 102 may be capable of communication via either or both of a wired LAN and a wireless LAN.

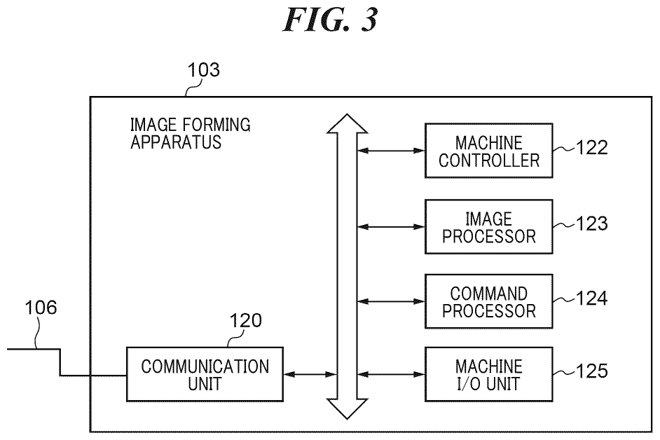

FIG. 3 is a block diagram illustrating the functions (software configuration) of the image forming apparatus. As illustrated in FIG. 3, the image forming apparatus 103 includes a communication unit 120, a machine controller 122, an image processor 123, a command processor 124, and a machine I/O unit 125. The communication unit 120 communicates with the information processing apparatus 102 via the network 106. For example, upon receipt of a print job or a machine control command from the information processing apparatus 102, the communication unit 120 sends a response to the information processing apparatus 102. The machine controller 122 is responsible for controlling each hardware component of the image forming apparatus 103. The machine controller 122 monitors, for example, various sensors such as a temperature sensor, usage rates of consumables, and failure statuses, or controls each hardware component during printing. The image processor 123 has functions related to print job control and printing. The command processor 124 has a function of processing commands for controlling the image forming apparatus 103. For example, in response to a control command received through the communication unit 120 or the machine I/O unit 125, the command processor 124 performs printing, turns off the power of the image forming apparatus 103, or performs printing based on a print job in cooperation with the image processor 123. The machine I/O unit 125 is responsible for controlling input devices such as the keyboard 208, output devices such as the display 209, and connected devices such as USB devices. The machine I/O unit 125 also receives inputs from various operation buttons of the image forming apparatus 103, such as a power button.

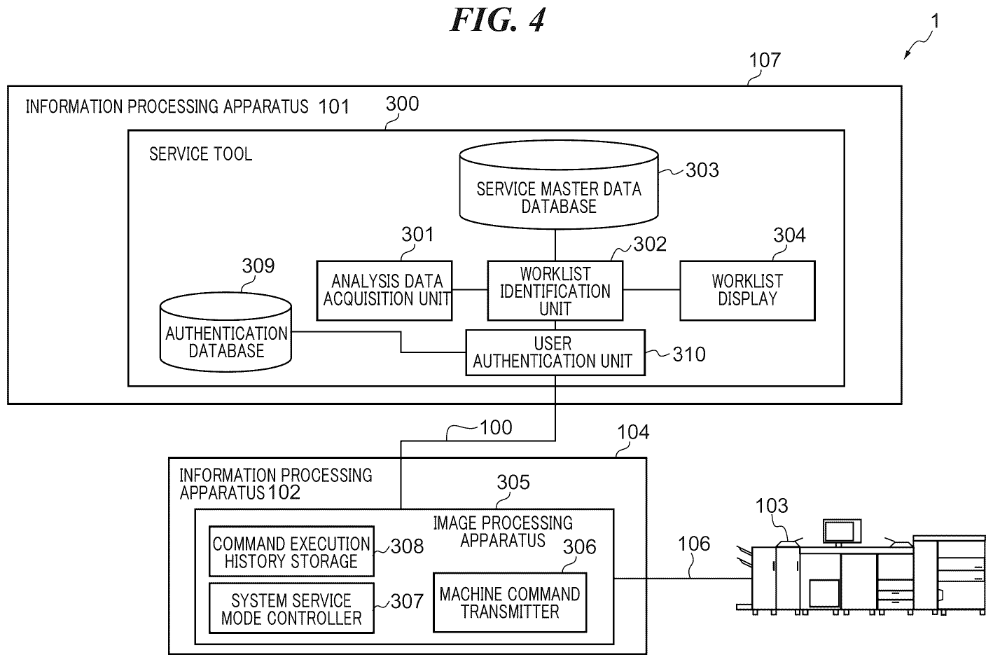

FIG. 4 is a block diagram illustrating the functions of the web system and the printing company system. As illustrated in FIG. 4, the information processing apparatus 102 in the printing company system 104 includes an image processing apparatus 305. The image processing apparatus 305 is configured to control maintenance tasks for the image forming apparatus 103 and is connected to the image forming apparatus 103 via the network 106. The image processing apparatus 305 is also connected to a service tool 300 of the information processing apparatus 101 via the Internet 100. The image processing apparatus 305 provides, remotely, the functions of the service tool 300 to a maintenance technician who performs maintenance tasks on-site where the printing company system 104 is installed. In addition, the image processing apparatus 305 uploads to the service tool 300 information such as the history of maintenance tasks performed by the maintenance technician, the wear status of consumables in the image forming apparatus 103, error information, and the history of print jobs. The image processing apparatus 305 may also upload analysis data to the service tool 300 in response to a request from the service tool 300. The image processing apparatus 305 includes applications configured to control the image forming apparatus 103. Specifically, the image processing apparatus 305 includes a machine command transmitter 306, a system service mode controller 307, and a command execution history storage 308. The machine command transmitter 306 sends commands to the image forming apparatus 103 to control the apparatus 103 or instruct operations such as printing. The system service mode controller 307 provides a user interface for operating the image forming apparatus 103. The command execution history storage 308 stores the history of machine command transmissions. The term “machine command” as used herein refers to a command directed to the image forming apparatus 103.

As illustrated in FIG. 4, the information processing apparatus 101 in the web system 107 includes the service tool 300. The service tool 300 is a software application configured to provide a maintenance technician with, for example, service manuals and tools necessary for maintenance inspections of the image forming apparatus 103, as well as other recommended maintenance tasks. In this embodiment, the information processing apparatus 101 includes the service tool 300; however, this is not a limitation, and, for example, the image processing apparatus 305 may include the service tool 300. The service tool 300 includes an analysis data acquisition unit 301, a worklist identification unit 302, a service master data database 303, a worklist display 304, an authentication database 309, and a user authentication unit 310. The analysis data acquisition unit 301 acquires analysis data stored in the image processing apparatus 305. The worklist identification unit 302 identifies recommended maintenance tasks or the like to be performed on the image forming apparatus 103 based on information such as errors recorded in the analysis data, usage levels and wear of consumables, the number of prints performed by the image forming apparatus 103, and counter values from sensors and the like provided in the image forming apparatus 103. The service master data database 303 stores a database that holds information necessary for maintenance inspections of the image forming apparatus 103. The worklist display 304 displays, on the service tool 300, the recommended maintenance tasks identified by the worklist identification unit 302. The authentication database 309 stores a database including user identification information, passwords, and the like for users of the service tool 300.

The user authentication unit 310 performs an authentication process to authenticate a user who uses the service tool 300. The user authentication unit 310 verifies identification information and a password registered in advance in the authentication database 309 in response to a request from the information processing apparatus 102. The service tool 300 can switch responses to the information processing apparatus 102 or delivery content according to the result of the verification performed by the user authentication unit 310. In this embodiment, the information processing apparatus 101 includes the authentication database 309 and the user authentication unit 310; however, this is not a limitation, and, for example, the information processing apparatus 102 or the image forming apparatus 103 may include the authentication database 309 and the user authentication unit 310. In addition, the number of instances of the authentication database 309 and the user authentication unit 310 is not particularly limited. The user authentication unit 310 may permit or prohibit the use of the service tool 300 for users not registered in the authentication database 309. In this embodiment, the user authentication unit 310 permits a user not registered in the authentication database 309 to use the service tool 300 as a guest user. The service tool 300 can determine, through the user authentication unit 310, that a guest user is using the information processing system 1.

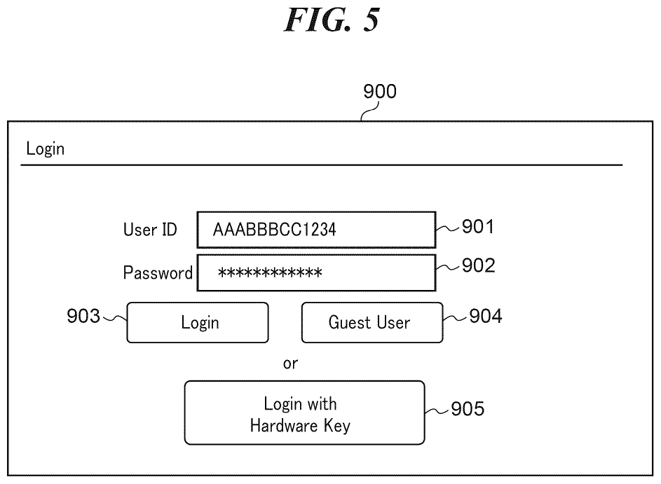

FIG. 5 is a diagram illustrating an example of a login screen. A login screen 900, as illustrated in FIG. 5, is used to perform an authentication operation to authenticate a user when the user uses the service tool 300. The login screen 900 is displayed on the display 209 of the information processing apparatus 102. The login screen 900 includes a user ID input field 901, a password input field 902, a login button 903, a guest user login button 904, and a hardware key login button 905. The user ID input field 901 is used to enter a user ID for identifying a user who uses the service tool 300. The password input field 902 is used to enter a password corresponding to the user ID. When the user ID is entered into the user ID input field 901 and the password is entered into the password input field 902, the login button 903 can be operated or pressed. This allows the user who has operated the login button 903 to log in to the service tool 300, i.e., to request user authentication from the service tool 300. In response to the user authentication request through the login screen 900, the service tool 300 performs an authentication process in the user authentication unit 310 and returns the processing result to the information processing apparatus 102. Alternatively, the guest user login button 904 can be operated without entering a user ID into the user ID input field 901 or a password into the password input field 902. In this case, a user who has operated the guest user login button 904 can log in to the service tool 300 as a guest user. In this case as well, the service tool 300 performs an authentication process in the user authentication unit 310 and returns the processing result to the information processing apparatus 102.

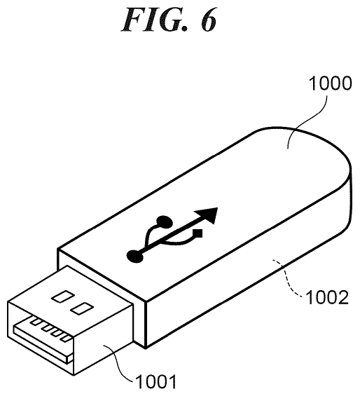

It is also possible to log in to the service tool 300 using a hardware key 1000 illustrated in FIG. 6. FIG. 6 is a perspective view illustrating a hardware key used for login. As illustrated in FIG. 6, the hardware key 1000 includes a USB terminal 1001 and a storage 1002 that stores the aforementioned user ID and password. When the USB terminal 1001 is connected to the USB controller 213 (USB port) of the information processing apparatus 102, the hardware key login button 905 can be operated. This allows the user to log in to the service tool 300. The vendor provides the hardware key 1000 in advance to a maintenance technician who is to be dispatched to a printing company. As a result, the maintenance technician can smoothly begin the login operation and maintenance tasks on-site. The authentication information stored in the hardware key 1000 is not limited to information related to the user ID and password; it may include any information that the user authentication unit 310 can use for authentication, such as encrypted data or a hash value. The device to which the hardware key 1000 is connected is not limited to the information processing apparatus 102 and may be, for example, the image forming apparatus 103. In this embodiment, login to the service tool 300 is performed from the information processing apparatus 102; however, this is not a limitation. For example, login may alternatively be performed from a server or another device on the network 106, as long as login to the service tool 300 is possible. Although the hardware key 1000 is configured to be connectable via the USB terminal 1001, it is not limited to USB connections. For example, the hardware key 1000 may instead be configured to be connectable via wireless communication. Alternatively, a card such as a security card may be used in place of the hardware key 1000.

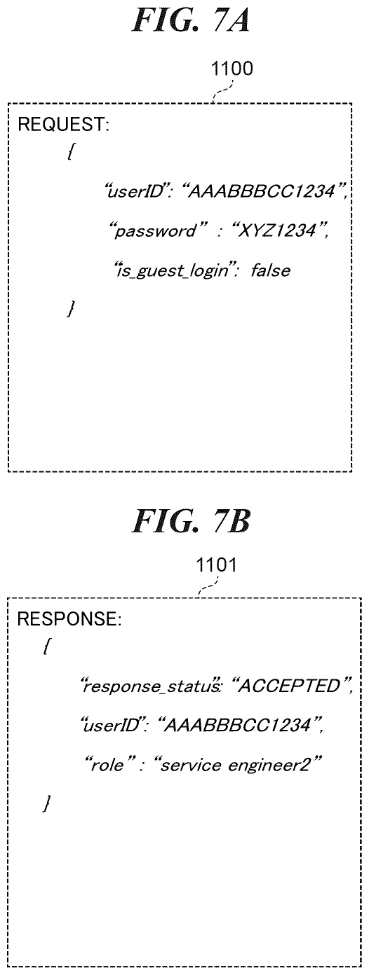

FIGS. 7A and 7B are diagrams illustrating example content of a request for user authentication to the service tool and example content of a response from the service tool, respectively. Request information 1100 illustrated in FIG. 7A includes request content. Specifically, the request information 1100 includes a user ID, a password, and a flag indicating whether guest login is to be used, each described in JavaScript Object Notation (JSON) format. Response information 1101 illustrated in FIG. 7B includes response content from the service tool 300, i.e., the processing result of user authentication in response to an authentication request from the information processing apparatus 102 to the service tool 300. Specifically, the response information 1101 includes the result of the authentication process, a user ID of the authenticated user, and attribute information of the user, each described in JSON format. The attribute information may include, for example, a user type such as a guest user, a service engineer, or a maintenance engineer. In this embodiment, while both the request information 1100 and the response information 1101 are described in JSON format, the format is not limited thereto. For example, the request information 1100 and the response information 1101 may be provided in other structured formats such as XML or even as plain text, or they may also be protected by a predetermined process such as encryption.

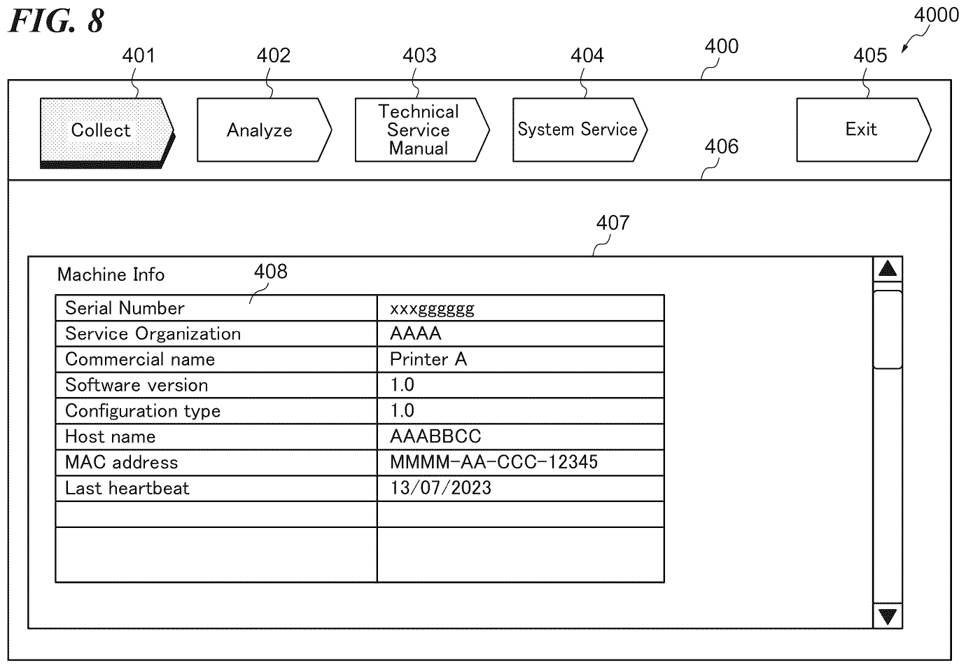

FIGS. 8 to 15 are diagrams each illustrating an operation screen that displays information related to the service tool. When a login operation on the login screen 900 is successfully completed, an operation screen 4000, as illustrated in FIGS. 8 to 15, is displayed on the display 209 of the information processing apparatus 102. This display is performed under the control of the controller 200 in the information processing apparatus 102. In this embodiment, the image forming apparatus 103 is registered in the service tool 300 as a maintenance target. The operation screen 4000 is used in a maintenance mode that enables maintenance inspections of the maintenance target, i.e., the image forming apparatus 103. A maintenance technician can check information related to the image forming apparatus 103 on the operation screen 4000. In this embodiment, the service tool 300 is displayed in full-screen mode as an on-premise application. In the printing industry, it is common to prepare a dedicated terminal device for operating or maintaining the image forming apparatus 103. On such terminal devices, the on-premise application is often displayed in full-screen mode. Note, however, that the service tool 300 may alternatively be displayed as a web application via a web browser such that it can be viewed and operated. Additionally, information may be displayed using HyperText Markup Language (HTML), JavaScript, or the like. As illustrated in FIG. 8, the operation screen 4000 includes a menu section 400 and a content display section 406. The menu section 400 includes an information collection button 401, an analysis button 402, a service manual button 403, a system service button 404, and an exit button 405. The content display section 406 displays information corresponding to operations on the respective buttons 401 to 405 or operations on the content display section 406. When the information collection button 401 is pressed, machine information (information collection screen) 407 is displayed in the content display section 406. The machine information 407 includes detailed machine information 408. The detailed machine information 408 is detailed information about the image forming apparatus 103. The detailed information is not particularly limited and may include, for example, a serial number of the image forming apparatus 103, a service organization, a commercial name, a software version, a MAC address, last communication date and time (last heartbeat), and the like.

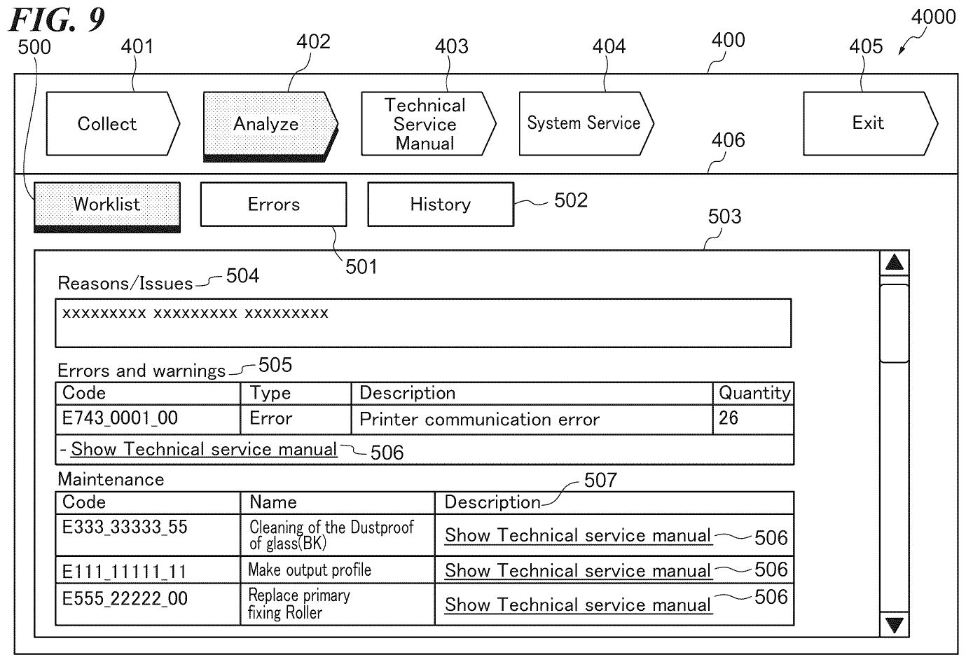

As illustrated in FIG. 9, when the analysis button 402 is pressed, a work list button 500, an error check button 501, and a history button 502 are displayed in the content display section 406. When the work list button 500 is pressed, a work list 503 is displayed in the content display section 406. Note that the analysis button 402 may be pressed to display the work list 503 in the content display section 406 for the first time.

The work list 503 includes a visit reason/issue input section 504, an error/warning display section 505, a service manual display button 506, and a maintenance display section 507. The visit reason/issue input section 504 allows entry of information such as the reason for the maintenance technician's visit and the details of issues or actions taken. The error/warning display section 505 displays information regarding errors that have occurred in the image forming apparatus 103. The error information is not particularly limited and may include, for example, an error code or the number of error occurrences. When the service manual display button 506 is pressed, registration information registered in the service master data database 303 is displayed. The registration information is not particularly limited and may include, for example, a URL of a technical service manual or the content of the technical service manual. For example, when each error is displayed in association with a corresponding technical service manual, the maintenance technician can quickly locate the technical service manual necessary to resolve the error. Incidentally, even for the same type of error, it may be necessary to change the work content or the like depending on the attribute information (conditions) of a worker who performs maintenance tasks, such as the skill level of the worker or the level of training they have received. Therefore, when the service manual display button 506 is pressed, the service tool 300 can display the content and URL of a service manual suitable for the user based on the attribute information of the user using the service tool 300. The maintenance display section 507 displays maintenance tasks such as replacement of parts (e.g., consumables) or cleaning. The maintenance display section 507 also includes the service manual display button 506.

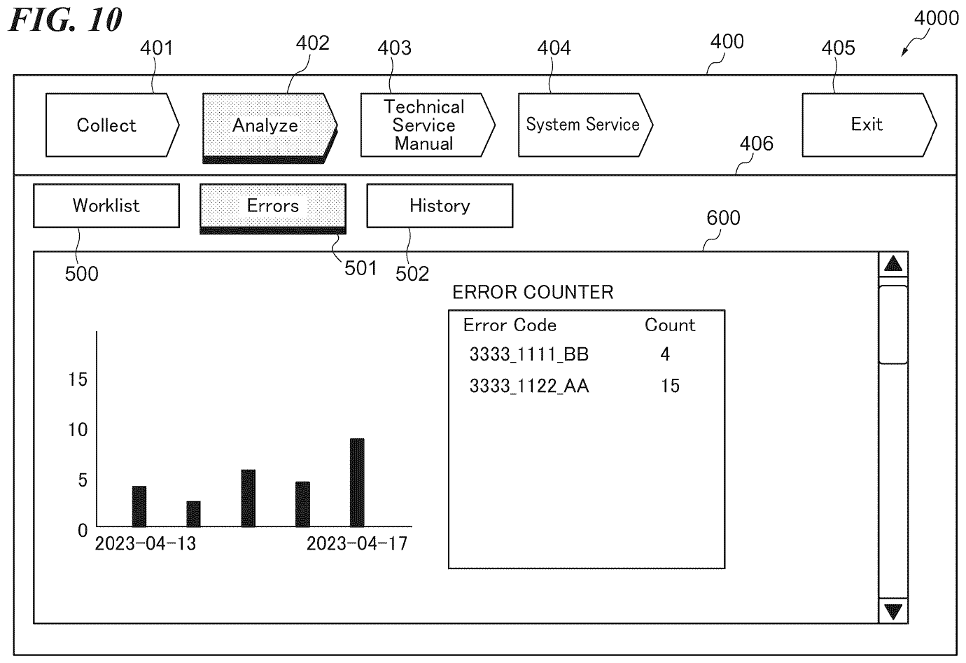

As illustrated in FIG. 10, when the error check button 501 is pressed, an error statistics information display section 600 is displayed in the content display section 406. The error statistics information display section 600 displays statistical information related to errors and warnings that have occurred in the image forming apparatus 103 over the past several days. The statistical information includes data such as error codes and a visual representation of the number of occurrences of each error. By reviewing the statistical information in the error statistics information display section 600, the maintenance technician can identify trends in errors occurring in the image forming apparatus 103. Understanding such error trends can assist in performing maintenance tasks.

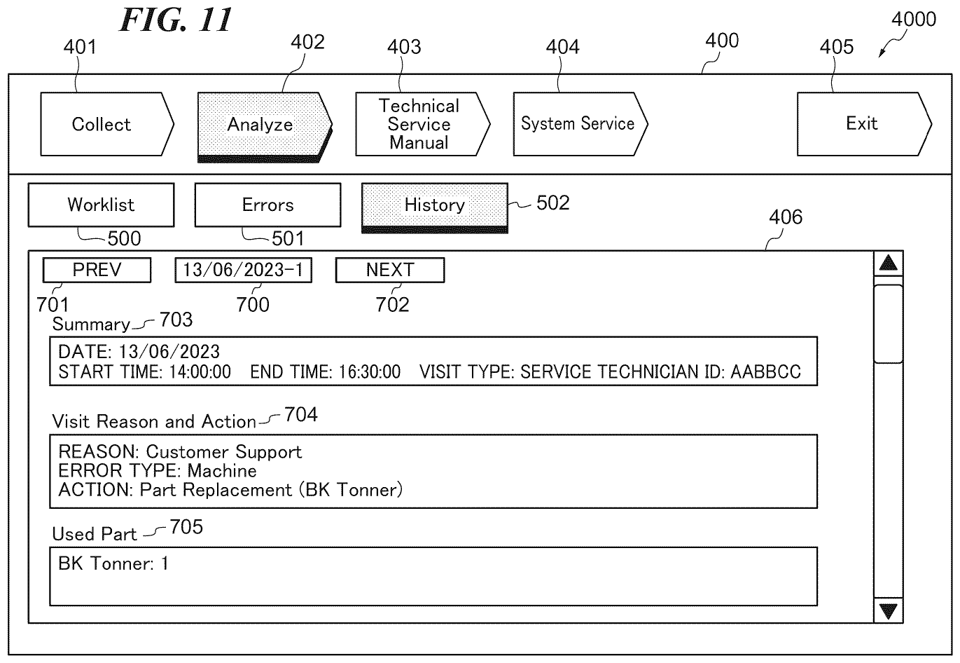

As illustrated in FIG. 11, when the history button 502 is pressed, a history date/time display section 700, a back (PREV) button 701, a forward (NEXT) button 702, a summary display section 703, a visit reason/action content display section 704, and a used part display section 705 are displayed in the content display section 406. The history date/time display section 700 displays the date and time of a history. By pressing the back button 701, the date and time of the history displayed in the history date/time display section 700 move backward, i.e., to a previous time. By pressing the forward button 702, the date and time of the history displayed in the history date/time display section 700 move forward. The summary display section 703 displays a summary of a visit history. For example, the summary display section 703 displays the visit date, the operation start time during the visit, the operation end time during the visit, the type of visit, and identification information of the maintenance technician. This information is entered by the maintenance technician. The visit reason/action content display section 704 displays the visit reason and action content recorded in the visit history. The used part display section 705 displays the types and quantities of replacement parts recorded in the visit history.

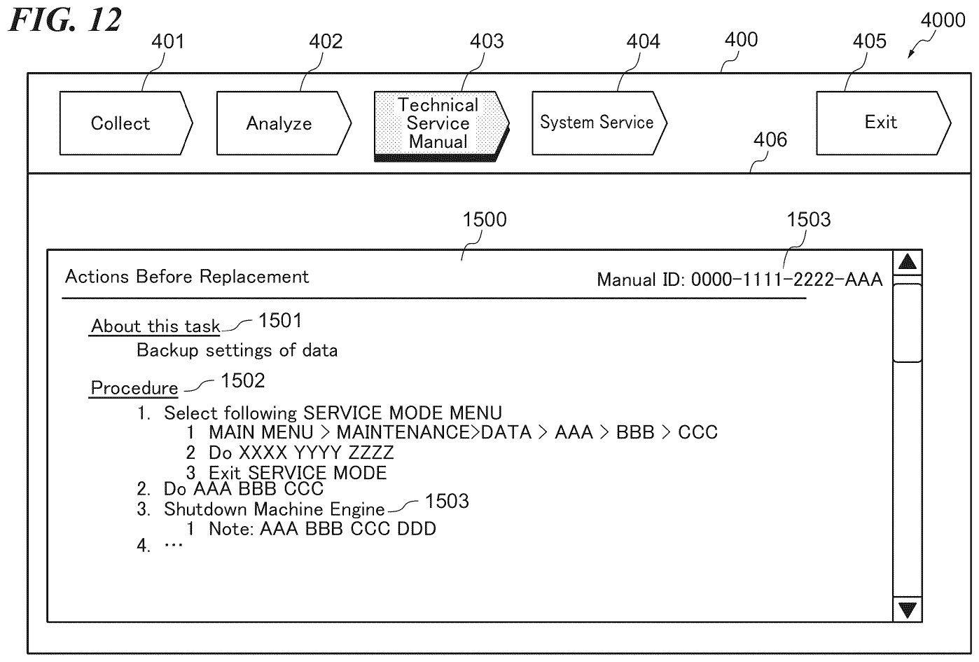

As illustrated in FIG. 12, when the service manual button 403 is pressed, a manual display section 1500 is displayed in the content display section 406. The manual display section 1500 displays a manual for performing a maintenance and inspection task and resolving an error. Specifically, the manual display section 1500 includes a task name 1501 and a procedure 1502. The task name 1501 indicates the name of a maintenance and inspection task. The procedure 1502 describes the content of the maintenance and inspection task. In the example of FIG. 12, the procedure includes a task description 1503 indicating that a shutdown of the image forming apparatus 103 is to be executed. The shutdown control that causes the image forming apparatus 103 to shut down is performed by the controller 200 of the information processing apparatus 102. The manual display section 1500 can also display the most recently accessed technical service manual when the service manual display button 506 is pressed.

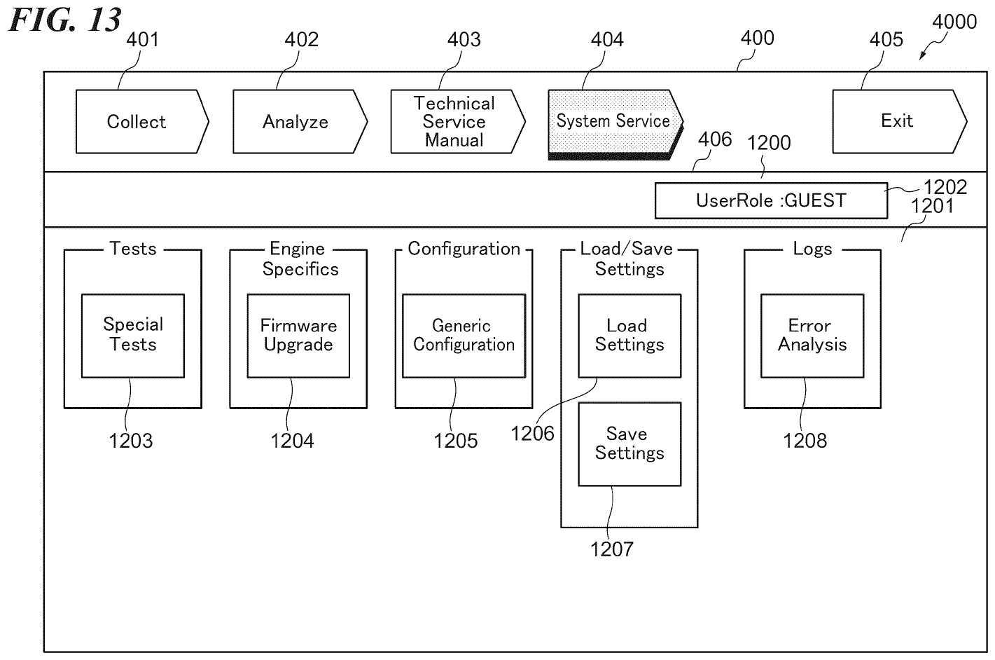

As illustrated in FIG. 13, when the system service button 404 is pressed, an interface or the like for performing operations necessary for a maintenance task of the image forming apparatus 103 is displayed in the content display section 406. Specifically, the content display section 406 includes a system service mode information display section 1200 and a menu display section (system service mode menu display section) 1201. The system service mode information display section 1200 displays information indicating that the current mode is a system service mode (maintenance mode), as well as user attribute information 1202. As described above, the attribute information may include, for example, a user type such as a guest user, a service engineer, or a maintenance engineer. In FIG. 13, “GUEST” indicating a guest user is displayed as an example of the user attribute information 1202. This guest user is a logged-in user who has logged in to the service tool in the system service mode. The menu display section 1201 displays buttons 1203 to 1208 which are operable by the user to implement functions in the system service mode. The button 1203 is used to implement a function related to tests necessary for a maintenance and inspection task. The button 1204 is used to implement a firmware upgrade function for the image forming apparatus 103. The button 1205 is used to implement a function to set operation conditions and the like for the image forming apparatus 103. The button 1206 is used to implement a function to load the settings of the image forming apparatus 103. The button 1207 is used to implement a function to save the settings of the image forming apparatus 103. The button 1208 is used to implement a function to output error information of the image forming apparatus 103.

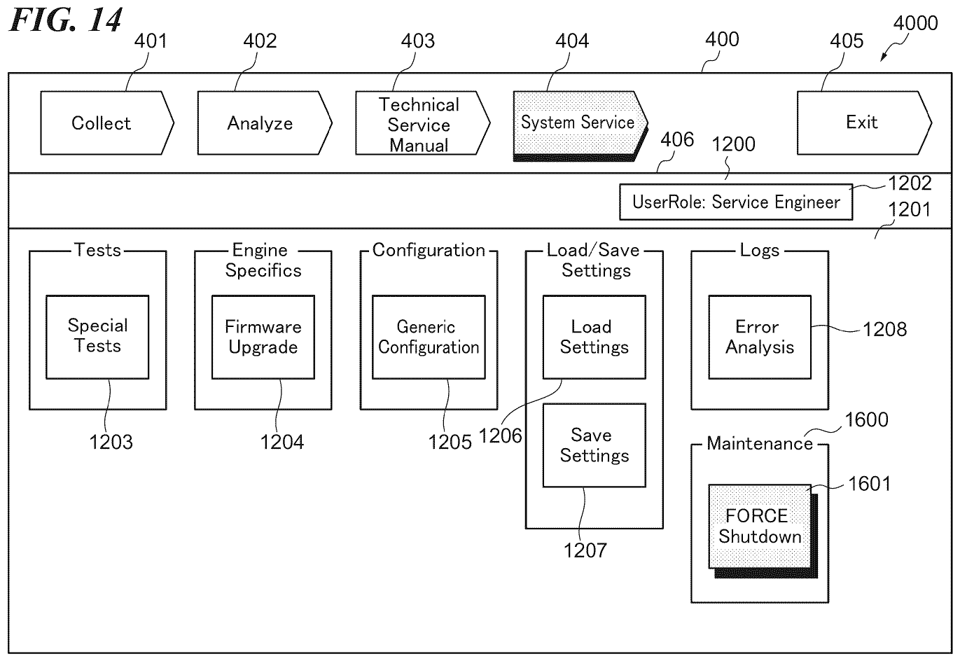

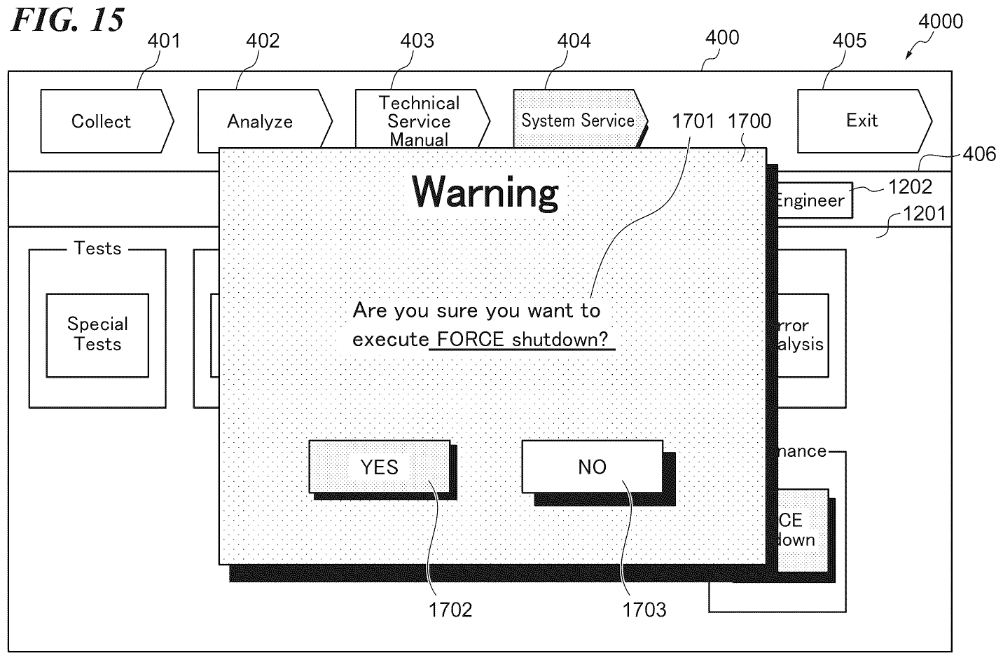

The operation screen 4000 illustrated in FIG. 14 differs from the operation screen 4000 illustrated in FIG. 13 in that “Service Engineer” is displayed as the user attribute information 1202. This service engineer is a logged-in user who has logged in to the service tool in the system service mode. In this case, in addition to the buttons 1203 to 1208, a maintenance button display section 1600 is displayed in the menu display section 1201 of the content display section 406. The maintenance button display section 1600 includes a forced shutdown button (operation section) 1601. When the forced shutdown button 1601 is pressed, a warning dialog 1700 is displayed superimposed on the operation screen 4000, as illustrated in FIG. 15.

Here, the forced shutdown will be described. The term “forced shutdown” refers to causing the image forming apparatus 103 to shut down without performing a protective process for protecting its components. In some image forming apparatuses, when a shutdown control is performed, a protective process is executed to prevent damage to components that are in operation in the apparatuses. For example, one such component of the image forming apparatus 103 is a drum. The temperature of the drum increases during operation, and if a cooling process is not performed as a protective process before shutdown, the drum may be damaged. The time required to execute such a protective process can range, for example, from 30 minutes to an hour, depending on the component to be protected. Consequently, a maintenance task after shutdown cannot begin until the protective process, which may take 30 minutes to an hour, has been completed. This may lead to reduced work efficiency; that is, more time may be required to complete the task. On the other hand, some components of the image forming apparatus 103 may not require a protective process. If only such components are in operation, a forced shutdown may be performed. Since service engineers have received specialized training in maintenance tasks, they can determine whether it is acceptable to execute a forced shutdown, depending on the type of maintenance task.

As described above, the warning dialog 1700 is displayed superimposed on the operation screen 4000 (see FIG. 15). The warning dialog 1700 is a confirmation screen used to confirm whether to execute a forced shutdown that omits the protective process. The warning dialog 1700 includes a confirmation message 1701, an execute button (first operation section) 1702, and a cancel button (second operation section) 1703. The confirmation message 1701 includes text prompting the service engineer (user) to confirm whether it is acceptable to execute a forced shutdown. The execute button 1702 is formed of a graphic (for example, a rectangle) and serves as an operation section on which an operation is performed to instruct the execution of a forced shutdown. When the execute button 1702 is operated, a forced shutdown command is sent to the image forming apparatus 103, thereby causing the image forming apparatus 103 to execute a forced shutdown. After the execute button 1702 is operated, the warning dialog 1700 is closed. The cancel button 1703 is an operation section on which an operation is performed to instruct the cancellation of a forced shutdown. The warning dialog 1700 is also closed after the cancel button 1703 is operated. This warning dialog 1700 serves to prevent even service engineers who have received specialized training in maintenance tasks from accidentally executing a forced shutdown.

As described above, the information processing apparatus 102 can switch whether to display the operation screen 4000 that allows an operation to instruct the execution of a forced shutdown, depending on the logged-in user who has logged in to the service tool in the system service mode, at the time of shutdown control. Specifically, when the logged-in user is a guest user, the operation screen 4000 that does not include the forced shutdown button 1601 (see FIG. 13) is displayed. Note that a physical shutdown button (not illustrated) provided on the image forming apparatus 103 is used to execute a shutdown accompanied by the protective process (i.e., not a forced shutdown). When this physical shutdown button is pressed, the command processor 124 and the machine controller 122 in the image forming apparatus 103 cause the image forming apparatus 103 to execute a shutdown accompanied by the protective process. On the other hand, when the logged-in user is a service engineer, the operation screen 4000 including the forced shutdown button 1601 (see FIG. 15) is displayed instead of the operation screen 4000 illustrated in FIG. 13.

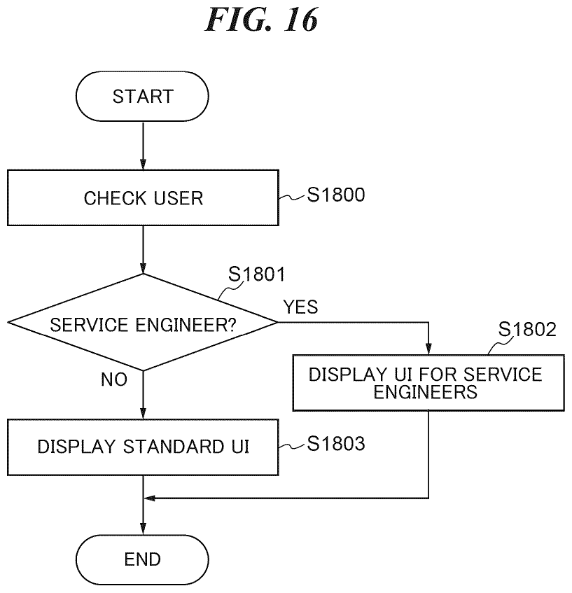

FIG. 16 is a flowchart illustrating a process performed by the information processing apparatus in the printing company system. A program based on the flowchart of FIG. 16 is initiated when the service manual button 403 (see FIG. 12) is pressed. As illustrated in FIG. 16, in step S1800, the image processing apparatus 305 checks the attribute information of the logged-in user. Specifically, it is checked whether the logged-in user is a guest user or a service engineer (a maintenance technician dispatched from a vendor), or the like. After completion of step S1800, the process proceeds to step S1801.

In step S1801, the image processing apparatus 305 determines whether the attribute information checked in step S1800 indicates that the user is a service engineer. If it is determined in step S1801 that the user is a service engineer, the process proceeds to step S1802. On the other hand, if it is determined in step S1801 that the user is not a service engineer, the process proceeds to step S1803.

In step S1802, the image processing apparatus 305 displays the operation screen 4000 for service engineers (see FIG. 14) on the display 209. After completion of step S1802, the process ends.

In step S1803, the image processing apparatus 305 displays the operation screen 4000 for users other than service engineers (see FIG. 13) on the display 209. After completion of step S1803, the process ends.

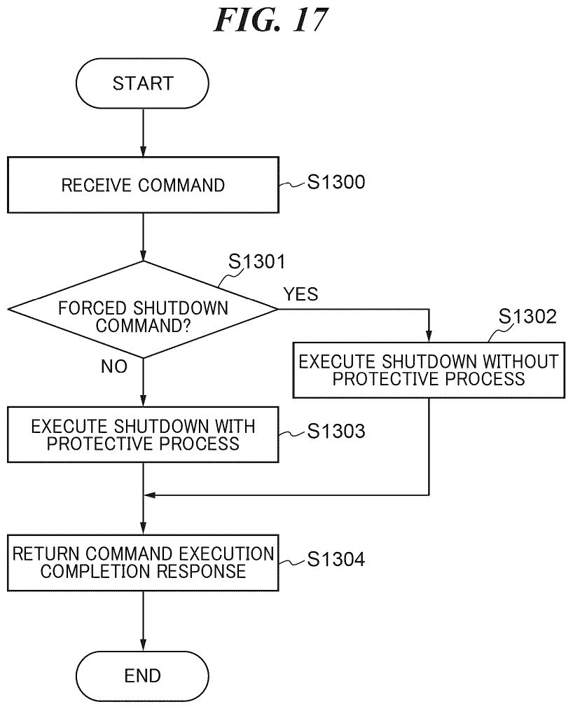

FIG. 17 is a flowchart illustrating a process performed by the image forming apparatus. As illustrated in FIG. 17, in step S1300, the command processor 124 receives a shutdown command. After completion of step S1300, the process proceeds to step S1301.

In step S1301, the command processor 124 determines whether the shutdown command received in step S1300 is a forced shutdown command. If it is determined in step S1301 that the command is a forced shutdown command, the process proceeds to step S1302. On the other hand, if it is determined in step S1301 that the command is not a forced shutdown command, the process proceeds to step S1303.

In step S1302, the command processor 124 executes a forced shutdown. Executing the forced shutdown saves the time that would otherwise be required for the protective process, thereby allowing subsequent maintenance tasks to start promptly. The forced shutdown may alternatively be executed by the machine controller 122. After completion of step S1302, the process proceeds to step S1304.

In step S1303, the command processor 124 executes a shutdown accompanied by the protective process. Through the protective process, for example, a cooling process is performed on the drum of the image forming apparatus 103, thereby preventing damage to the drum. After completion of step S1303, the process proceeds to step S1304.

In step S1304, the command processor 124 returns to the communication unit 120 a command execution completion response indicating that the shutdown command has been executed. After completion of step S1304, the process ends.

As described above, in the information processing apparatus 102, prior to controlling whether to display the operation screen 4000 illustrated in FIG. 14 or the operation screen 4000 illustrated in FIG. 13, it is determined whether the logged-in user is a service engineer. If it is determined that the logged-in user is a service engineer, the operation screen 4000 illustrated in FIG. 14 is displayed. On the other hand, if it is determined that the logged-in user is not a service engineer, the operation screen 4000 illustrated in FIG. 13 is displayed. This display control enables quick switching between the operation screen 4000 illustrated in FIG. 14 and the operation screen 4000 illustrated in FIG. 13, depending on the logged-in user. When the operation screen 4000 illustrated in FIG. 14 is displayed, a service engineer can press the forced shutdown button 1601 and the execute button 1702 in sequence. As a result, a forced shutdown is executed, saving the time required for the protective process. On the other hand, when the operation screen 4000 illustrated in FIG. 13 is displayed, a guest user, for example, can press the physical shutdown button. This causes a shutdown accompanied by the protective process to be executed. Through the protective process, for example, a cooling process is performed on the drum of the image forming apparatus 103, thereby preventing damage to the drum. In this manner, the information processing apparatus 102 can perform an appropriate shutdown of the image forming apparatus 103.

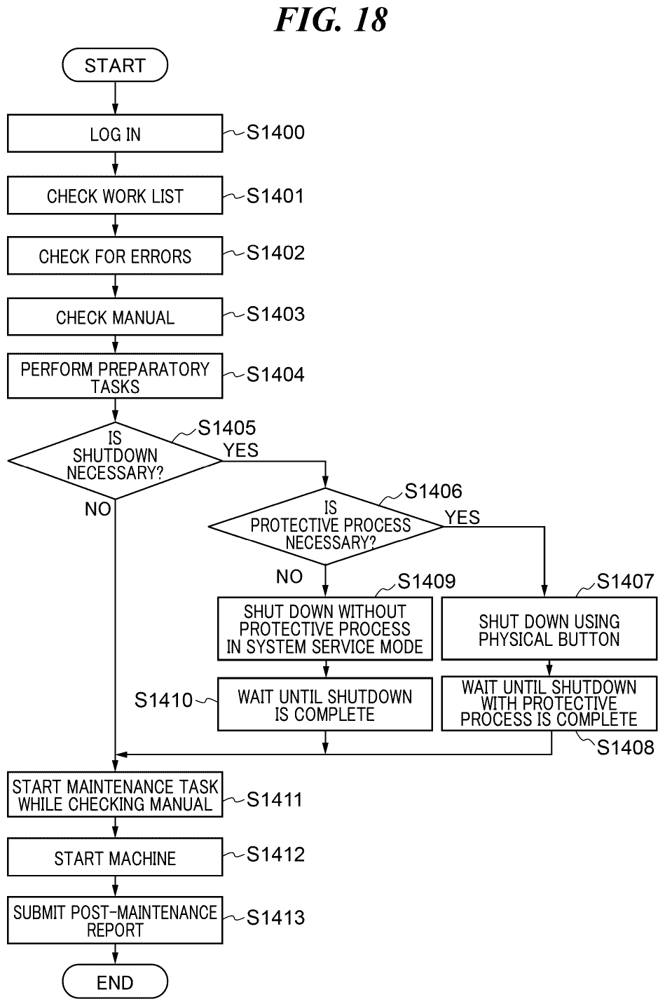

FIG. 18 is a flowchart illustrating a process performed by a service engineer (maintenance technician) for a maintenance task. The service engineer performs the maintenance task while checking the operation screen 4000 displayed on the display 209 of the information processing apparatus 102. As illustrated in FIG. 18, in step S1400, the service engineer performs a login operation on the login screen 900 displayed on the display 209 of the information processing apparatus 102. If the login operation is successfully completed, the operation screen 4000 is displayed on the display 209. After completion of step S1400, the process proceeds to step S1401.

In step S1401, the service engineer presses the analysis button 402 and the work list button 500 (see FIG. 9) on the operation screen 4000 in sequence. As a result, the work list 503 is displayed. The service engineer checks a list of maintenance tasks for the image forming apparatus 103 on the work list 503. After completion of step S1401, the process proceeds to step S1402.

In step S1402, the service engineer checks the error details on the work list 503. After completion of step S1402, the process proceeds to step S1403.

In step S1403, the service engineer presses the service manual button 403 (see FIG. 12) on the operation screen 4000. As a result, the manual display section 1500 is displayed. The service engineer checks the service manual and task details on the manual display section 1500. After completion of step S1403, the process proceeds to step S1404.

In step S1404, the service engineer performs any necessary preparatory tasks, such as configuring the settings of the image forming apparatus 103. After completion of step S1404, the process proceeds to step S1405.

In step S1405, the service engineer determines whether a shutdown of the image forming apparatus 103 is necessary based on the service manual and task details checked in step S1403. If it is determined in step S1405 that a shutdown is necessary, the process proceeds to step S1406. On the other hand, if it is determined in step S1405 that a shutdown is not necessary, i.e., unnecessary, the process proceeds to step S1411.

In step S1406, the service engineer determines whether a shutdown accompanied by the protective process is necessary based on the content of the service manual checked in step S1403, as well as their technical knowledge or the like. If it is determined in step S1406 that a shutdown accompanied by the protective process is necessary, the process proceeds to step S1407. On the other hand, if it is determined in step S1406 that a shutdown accompanied by the protective process is not necessary, the process proceeds to step S1409.

In step S1407, the service engineer presses the physical shutdown button. This allows the image forming apparatus 103 to execute a shutdown accompanied by the protective process. After completion of step S1407, the process proceeds to step S1408.

In step S1408, the service engineer waits until the shutdown accompanied by the protective process is complete. After completion of step S1408, the process proceeds to step S1411.

In step S1409, the service engineer presses the system service button 404 (see FIG. 14) on the operation screen 4000. As a result, the forced shutdown button 1601 is displayed. The service engineer presses the forced shutdown button 1601, thereby allowing the image forming apparatus 103 to execute a forced shutdown. After completion of step S1409, the process proceeds to step S1410.

In step S1410, the service engineer waits until the forced shutdown is complete. After completion of step S1410, the process proceeds to step S1411.

In step S1411, the service engineer presses the service manual button 403 (see FIG. 12) on the operation screen 4000 again. As a result, the manual display section 1500 is displayed. The service engineer performs a maintenance task while checking the service manual on the manual display section 1500. After completion of step S1411, the process proceeds to step S1412.

In step S1412, the service engineer restarts the image forming apparatus 103 as needed. After completion of step S1412, the process proceeds to step S1413.

In step S1413, the service engineer presses the analysis button 402 (see FIG. 9). As a result, the work list 503 is displayed. The service engineer records the current maintenance task in the work list 503. After completion of step S1413, the process ends.

### Second Embodiment

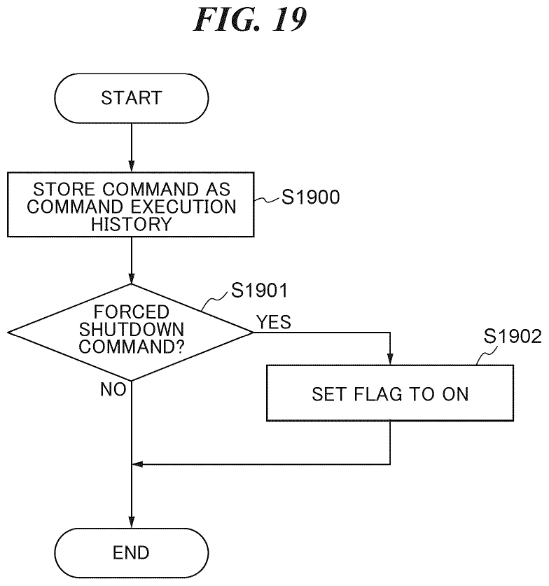

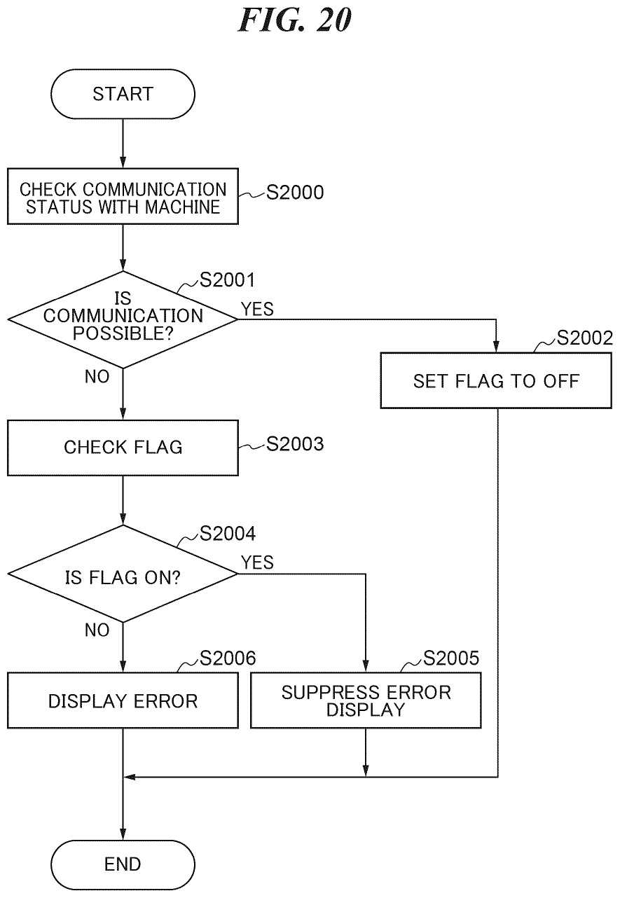

A second embodiment will be described below with reference to FIGS. 19 and 20, focusing on differences from the previously described embodiment without repeating the same explanations. FIG. 19 is a flowchart illustrating a process performed by the information processing apparatus in the printing company system according to the second embodiment. A program based on the flowchart of FIG. 19 is initiated when the image processing apparatus 305 instructs the machine command transmitter 306 to transmit a machine command. As illustrated in FIG. 19, in step S1900, the machine command transmitter 306 checks a machine command transmitted according to an instruction from the image processing apparatus 305 and stores the machine command in the command execution history storage 308 as a command execution history. After completion of step S1900, the process proceeds to step S1901.

In step S1901, the machine command transmitter 306 determines whether the machine command transmitted according to an instruction from the image processing apparatus 305 is a forced shutdown command. If it is determined in step S1901 that the command is a forced shutdown command, the process proceeds to step S1902. On the other hand, if it is determined in step S1901 that the command is not a forced shutdown command, the process ends.

In step S1902, the machine command transmitter 306 sets a flag to ON to indicate that the machine command transmitted according to an instruction from the image processing apparatus 305 is a forced shutdown command and stores the flag in the command execution history storage 308. This flag also serves as evidence that the forced shutdown was intentionally executed by the service engineer. After completion of step S1902, the process ends.

When a forced shutdown is executed, an error is generally notified. However, execution of a forced shutdown via the forced shutdown button 1601 is an intentional operation and therefore does not constitute an error. Accordingly, it is preferable that no error notification be issued. This embodiment describes a configuration and operation that suppresses error notification upon forced shutdown.

FIG. 20 is a flowchart illustrating a process performed by the information processing apparatus in the printing company system. A program based on the flowchart of FIG. 20 may be initiated when the image processing apparatus 305 communicates with the image forming apparatus 103 to check its status as part of periodic polling. Alternatively, the program may be initiated when an operation is performed to display information (e.g., the machine information 407) of the service tool 300, thereby causing communication with the image forming apparatus 103. As illustrated in FIG. 20, in step S2000, the image processing apparatus 305 checks the communication status with the image forming apparatus 103. After completion of step S2000, the process proceeds to step S2001.

In step S2001, the image processing apparatus 305 determines whether communication with the image forming apparatus 103 is possible based on the communication status checked in step S2000. If it is determined in step S2001 that communication is possible, the process proceeds to step S2002. On the other hand, if it is determined in step S2001 that communication is not possible, the process proceeds to step S2003.

In step S2002, the image processing apparatus 305 sets the flag to OFF for the forced shutdown command stored in the command execution history storage 308. After completion of step S2002, the process ends.

In step S2003, the image processing apparatus 305 checks the status of the flag for the forced shutdown command stored in the command execution history storage 308. After completion of step S2003, the process proceeds to step S2004.

In step S2004, the image processing apparatus 305 determines whether the flag is ON based on the status of the flag checked in step S2003. If it is determined in step S2004 that the flag is ON, the process proceeds to step S2005. On the other hand, if it is determined in step S2004 that the flag is not ON, i.e., the flag is OFF, the process proceeds to step S2006.

In step S2005, the image processing apparatus 305 suppresses the display (notification) of an error indicating a forced shutdown on the error/warning display section 505, the error statistics information display section 600, and the like. In addition, the image processing apparatus 305 performs a process to exclude the current error from the error details to be reported to the service tool 300. After completion of step S2005, the process ends.

In step S2006, the image processing apparatus 305 displays an error indicating a forced shutdown on the error/warning display section 505, the error statistics information display section 600, and the like. The image processing apparatus 305 also performs a process to include the current error in the error details to be reported to the service tool 300. After completion of step S2006, the process ends.

As described above, in this embodiment, since execution of a forced shutdown via the forced shutdown button 1601 is an intentional operation, the error notification is suppressed.

### Third Embodiment

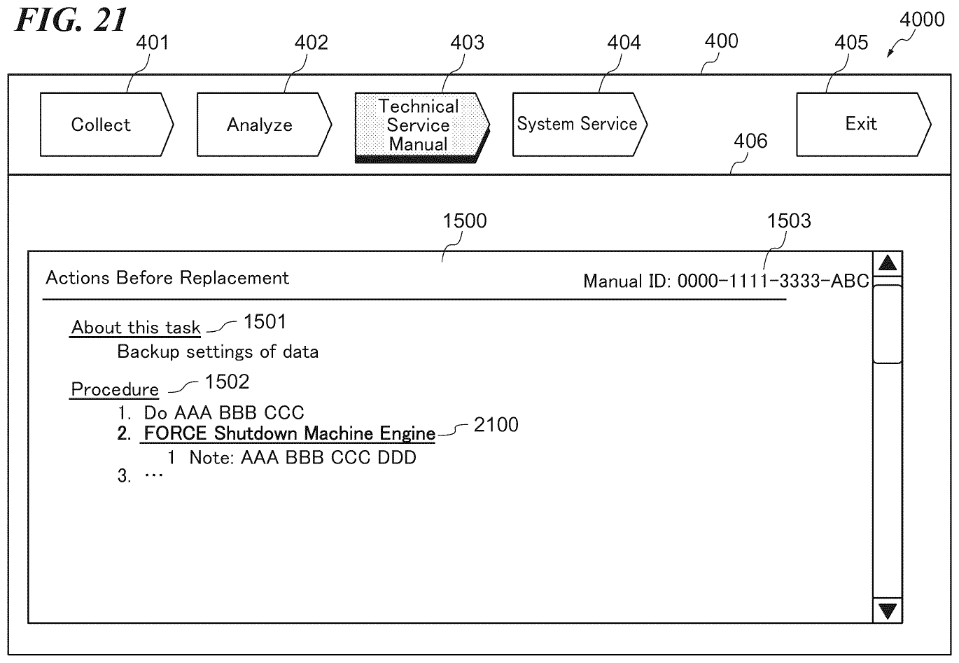

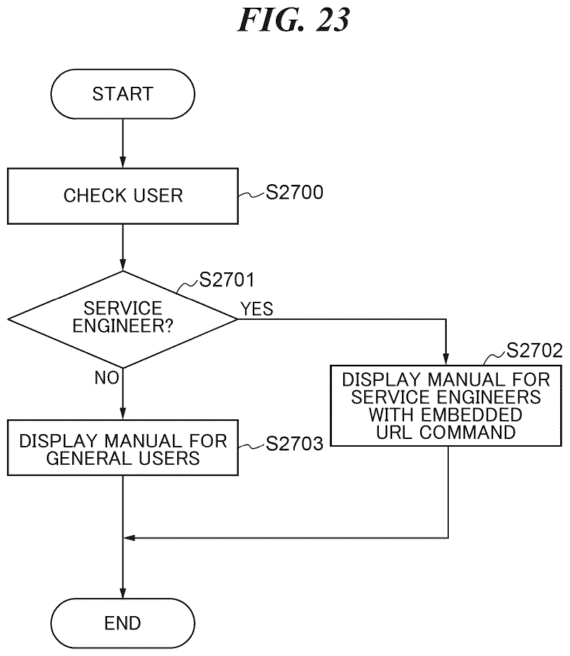

A third embodiment will be described below with reference to FIGS. 21 and 23, focusing on differences from the previously described embodiments without repeating the same explanations. FIG. 21 is a diagram illustrating an operation screen that displays information related to the service tool according to the third embodiment. As illustrated in FIG. 21, when the service manual button 403 is pressed, the manual display section 1500 is displayed in the content display section 406. This display can also be triggered, for example, by clicking a URL linked to a technical service manual (not illustrated). The manual display section 1500 includes a link 2100, which functions as a forced shutdown button, in the procedure 1502. The link 2100 is a URL (character string) used to execute a forced shutdown. When the link 2100 is clicked, the image processing apparatus 305 transmits a forced shutdown command to the image forming apparatus 103 in cooperation with the machine command transmitter 306 and the system service mode controller 307. Thus, a forced shutdown can be executed. The presence of the link 2100 makes it possible to omit switching control between the operation screen 4000 illustrated in FIG. 13 and the operation screen 4000 illustrated in FIG. 14 during maintenance tasks that do not require a forced shutdown. For example, this eliminates the need to sequentially operate the forced shutdown button 1601 and the execute button 1702, thereby improving the operability of the operation screen 4000.

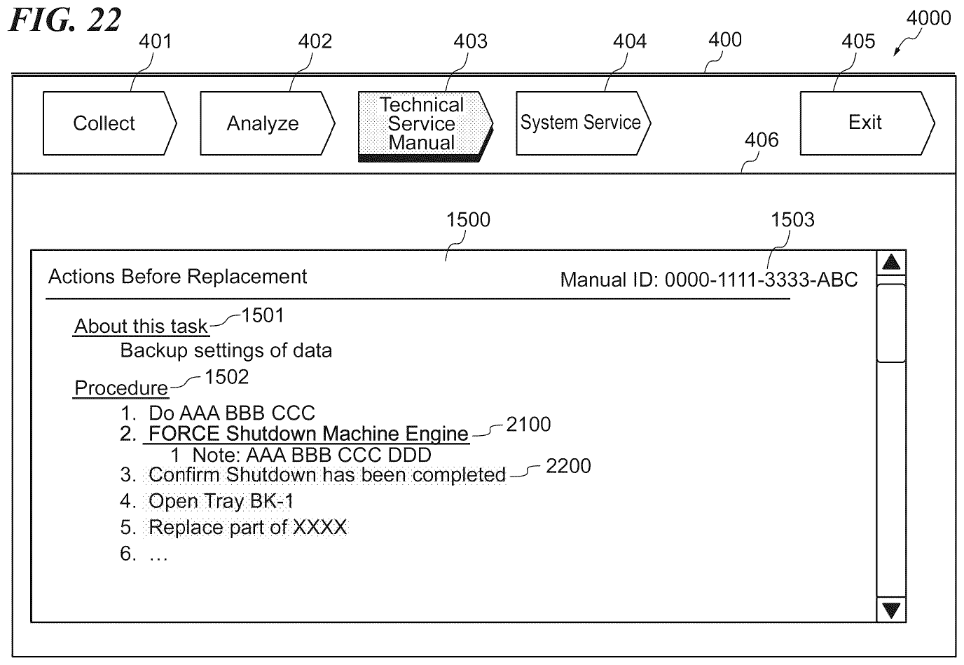

FIG. 22 is a diagram illustrating an operation screen that displays information related to the service tool. As illustrated in FIG. 22, in the manual display section 1500, a character string 2200 indicating the content of the next task is highlighted to assist the service engineer in understanding the task content. This allows maintenance tasks to be performed quickly while preventing operational errors.

FIG. 23 is a flowchart illustrating a process performed by the information processing apparatus in the printing company system. A program based on the flowchart of FIG. 23 is initiated when the image processing apparatus 305 displays a service manual for checking an error or the like. As illustrated in FIG. 23, in step S2700, the image processing apparatus 305 checks the attribute information of the logged-in user.

In step S2701, the image processing apparatus 305 determines whether the attribute information checked in step S2700 indicates that the user is a service engineer. If it is determined in step S2701 that the user is a service engineer, the process proceeds to step S2702. On the other hand, if it is determined in step S2701 that the user is not a service engineer, the process proceeds to step S2703.

In step S2702, the image processing apparatus 305 displays the operation screen 4000 for service engineers (see FIG. 21), which includes the link 2100, on the display 209. After completion of step S2702, the process ends.

In step S2703, the image processing apparatus 305 displays the operation screen 4000 for users other than service engineers, which does not include the link 2100, on the display 209. After completion of step S2703, the process ends.

### Fourth Embodiment

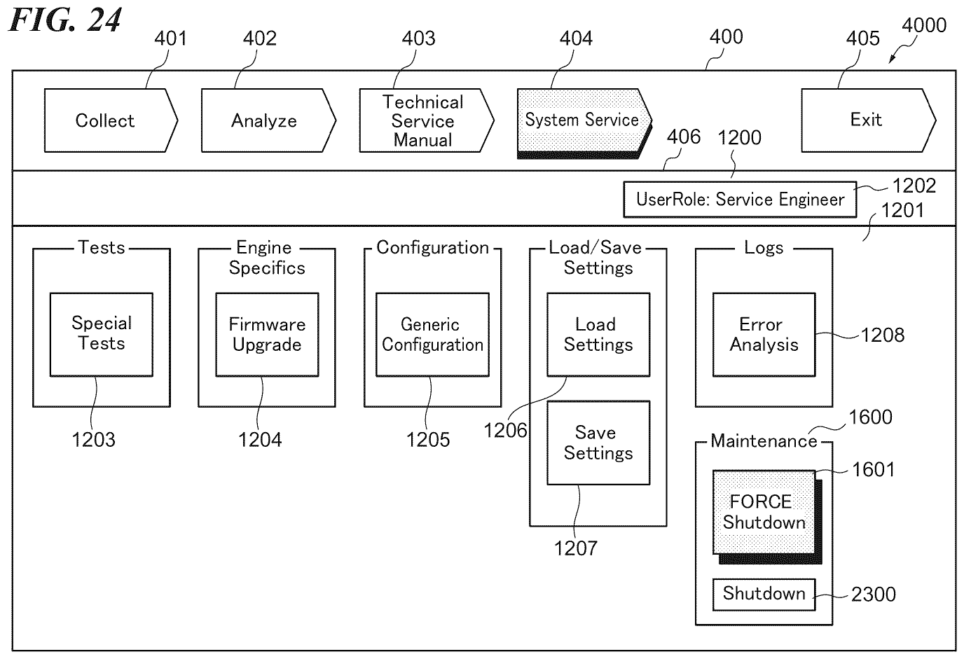

A fourth embodiment will be described below with reference to FIGS. 24 to 27, focusing on differences from the previously described embodiments without repeating the same explanations. FIGS. 24 to 27 are diagrams each illustrating an operation screen that displays information related to the service tool according to the fourth embodiment. In the operation screen 4000 illustrated in FIG. 24, the user attribute information 1202 indicates a service engineer. Unlike the operation screen 4000 illustrated in FIG. 14, the operation screen 4000 illustrated in FIG. 24 includes, in the maintenance button display section 1600, a shutdown button 2300 in addition to the forced shutdown button 1601. The shutdown button 2300 is used to execute a shutdown accompanied by the protective process.

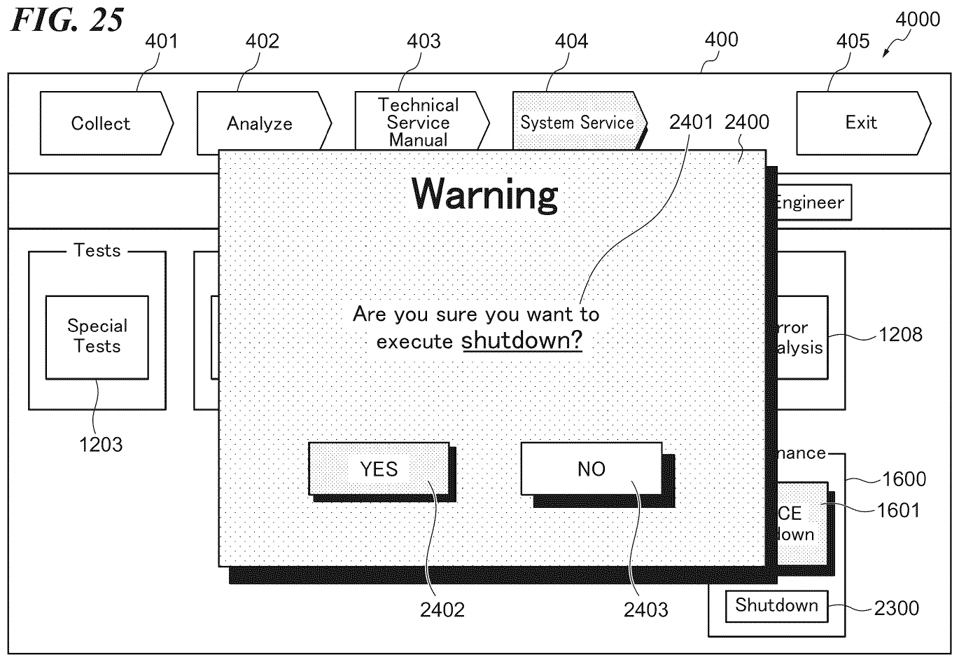

When the shutdown button 2300 is pressed, a warning dialog 2400 is displayed superimposed on the operation screen 4000, as illustrated in FIG. 25. The warning dialog 2400 is a confirmation screen used to confirm whether to execute a shutdown accompanied by the protective process. The warning dialog 2400 includes a confirmation message 2401, an execute button 2402, and a cancel button 2403. The confirmation message 2401 includes text prompting the service engineer (user) to confirm whether it is acceptable to execute a normal (or standard) shutdown accompanied by the protective process. Executing a shutdown accompanied by the protective process causes the image forming apparatus 103 to stop, which may interfere with operations using the image forming apparatus 103. Therefore, the confirmation message 2401 is provided so that the user can confirm it before executing the shutdown accompanied by the protective process. When the execute button 2402 is pressed, a command to execute a shutdown accompanied by the protective process is sent to the image forming apparatus 103, causing the image forming apparatus 103 to execute a shutdown accompanied by the protective process. After the execute button 2402 is operated, the warning dialog 2400 is closed. The cancel button 2403 is an operation section on which an operation is performed to instruct the cancellation of a shutdown accompanied by the protective process. The warning dialog 2400 is also closed after the cancel button 2403 is operated.

On the operation screen 4000 illustrated in FIG. 24, there is a risk of erroneous operation due to confusion between the forced shutdown button 1601 and the shutdown button 2300. Therefore, at the time when the cancel button 1703 is pressed, the warning dialog 2400 may be displayed to confirm whether the user intended to execute a shutdown accompanied by the protective process. This helps reduce operational errors.

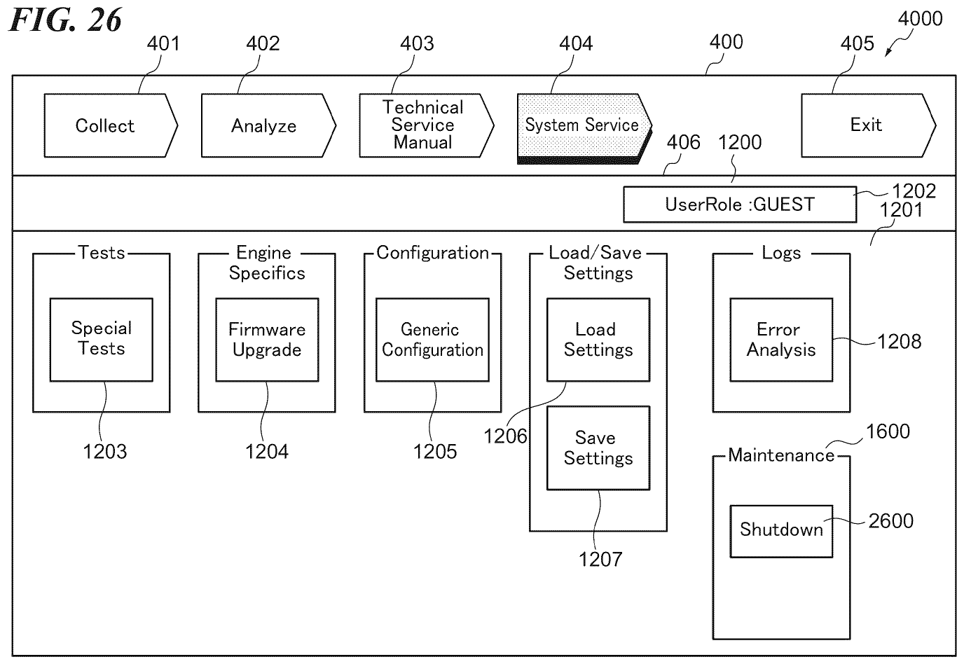

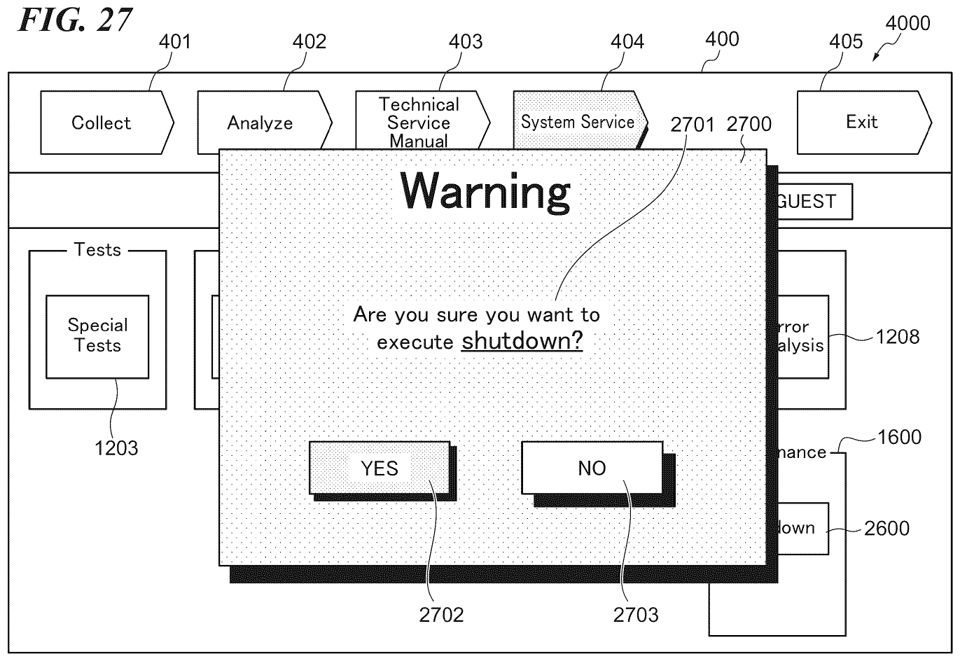

In the operation screen 4000 illustrated in FIG. 26, the user attribute information 1202 indicates a guest user. Unlike the operation screen 4000 illustrated in FIG. 13, the operation screen 4000 illustrated in FIG. 26 includes the maintenance button display section 1600. The maintenance button display section 1600 includes a shutdown button 2600. The shutdown button 2600 is an operation button used to execute a shutdown accompanied by the protective process. When the shutdown button 2600 is pressed, a warning dialog 2700 is displayed superimposed on the operation screen 4000, as illustrated in FIG. 27. The warning dialog 2700 is a confirmation screen used to confirm whether to execute a shutdown accompanied by the protective process. The warning dialog 2700 includes a confirmation message 2701, an execute button 2702, and a cancel button 2703. The confirmation message 2701 includes text prompting the guest user to confirm whether it is acceptable to execute a normal (or standard) shutdown accompanied by the protective process. As described above, when the execute button 2702 is operated, the image forming apparatus 103 can be caused to execute a shutdown accompanied by the protective process. After the execute button 2702 is operated, the warning dialog 2700 is closed. The cancel button 2703 is an operation section on which an operation is performed to instruct the cancellation of a shutdown accompanied by the protective process. The warning dialog 2700 is also closed after the cancel button 2703 is operated.

As described above, in this embodiment, switching control is performed to switch between the operation screen 4000 illustrated in FIG. 24 and the operation screen 4000 illustrated in FIG. 26, depending on the logged-in user. The operation screen 4000 illustrated in FIG. 24 is a screen (second operation screen) that allows an operation to instruct the execution of a forced shutdown. The operation screen 4000 illustrated in FIG. 26 is a screen (first operation screen) that allows an operation to instruct the execution of a shutdown accompanied by the protective process. Specifically, when the logged-in user is a service engineer, the operation screen 4000 illustrated in FIG. 24 is displayed. When the logged-in user is a guest user, the operation screen 4000 illustrated in FIG. 26 is displayed. Such switching control can improve the convenience of both maintenance tasks and regular printing operations.

According to the above embodiments, an appropriate shutdown can be performed for the image forming apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-144218, filed Aug. 26, 2024, which is hereby incorporated by reference herein in its entirety.

What is claimed is:

1. An information processing apparatus configured to be communicatively connected to an image forming apparatus, the apparatus comprising:
one or more processors; and
at least one memory coupled to the one or more processors and having stored thereon instructions which, when executed by the one or more processors, cause the one or more processors to:
perform shutdown control to cause the image forming apparatus to execute a shutdown; and
control, upon performing the shutdown control, whether to display an operation screen that allows an operation to instruct execution of the shutdown without performing a protective process for protecting components of the image forming apparatus, depending on a logged-in user who has logged in using a maintenance mode that enables maintenance inspection of the image forming apparatus.

2. The information processing apparatus according to claim 1, wherein the instructions further cause the one or more processors to:
determine whether the logged-in user is eligible to instruct execution of the shutdown without performing the protective process prior to controlling whether to display the operation screen;
display the operation screen when it is determined that the logged-in user is eligible to instruct execution of the shutdown without performing the protective process; and
refrain from displaying the operation screen when it is determined that the logged-in user is not eligible to instruct execution of the shutdown without performing the protective process.

3. The information processing apparatus according to claim 2, wherein
the operation screen includes an operation section configured to be operated to instruct execution of the shutdown without performing the protective process, and
the instructions further cause the one or more processors to display a screen without the operation section, when not displaying the operation screen.

4. The information processing apparatus according to claim 1, wherein the operation screen includes an operation section configured to be operated to instruct execution of the shutdown without performing the protective process.

5. The information processing apparatus according to claim 4, wherein the operation section includes a graphic or a character string.

6. The information processing apparatus according to claim 4, wherein the instructions further cause the one or more processors to display a confirmation screen to confirm whether to execute the shutdown without performing the protective process, when the operation section is operated.

7. The information processing apparatus according to claim 6, wherein the confirmation screen includes a first operation section configured to be operated to instruct execution of the shutdown without performing the protective process, and a second operation section configured to be operated to instruct cancellation of the shutdown without performing the protective process.

8. The information processing apparatus according to claim 7, wherein the instructions further cause the one or more processors to cause the image forming apparatus to execute the shutdown without performing the protective process when the first operation section is operated.

9. The information processing apparatus according to claim 1, wherein the instructions further cause the one or more processors to:
notify, in principle, an error when the shutdown without performing the protective process is executed;
store information indicating a history of the shutdown without performing the protective process, when the shutdown is executed in response to an operation performed on the operation screen; and
suppress notification of the error based on the information stored.

10. The information processing apparatus according to claim 1, wherein the instructions further cause the one or more processors to display information related to the maintenance inspection when the shutdown without performing the protective process is executed.

11. A method of controlling an information processing apparatus that is communicatively connected to an image forming apparatus, the method comprising:
performing shutdown control to cause the image forming apparatus to execute a shutdown; and
controlling, upon performing the shutdown control, whether to display an operation screen that allows an operation to instruct execution of the shutdown without performing a protective process for protecting components of the image forming apparatus, depending on a logged-in user who has logged in using a maintenance mode that enables maintenance inspection of the image forming apparatus.

12. A method of controlling an information processing apparatus that is communicatively connected to an image forming apparatus, the method comprising:
performing shutdown control to cause the image forming apparatus to execute a shutdown; and
performing switching control, upon performing the shutdown control, to control whether to display a first operation screen that allows an operation to instruct execution of the shutdown after completion of a protective process for protecting components of the image forming apparatus, or a second operation screen that allows an operation to instruct execution of the shutdown without performing the protective process.

13. A computer program product, comprising a non-transitory computer-readable medium having stored thereon computer-executable instructions which, when executed by a computer, cause the computer to function as the information processing apparatus according to claim 1.
